(19) United States
(12) Patent Application Publication
(10) Pub. No.: US 2006/0060147 A1
(43) Pub. Date: Mar. 23, 2006

(54) Pet bed cover

(76) Inventor: Jacqueline M. Appelhans, Salem, WI (US)

Correspondence Address: JANSSON, SHUPE, MUNGER & ANTARAMIAN, LTD, 245 MAIN STREET, RACINE, WI, 53403, US

(21) Appl. No.: 10/947,597

(22) Filed: Sep. 22, 2004

(51) Int. Cl. A01K 29/00

(52) U.S. Cl. 119/28.5

(57) ABSTRACT

A disposable cover for a pet bed or resting surface comprises an outer layer having a perimeter; an elastic member located about the perimeter for fixing the cover with respect to the pet bed/resting surface; an inner layer for contact with the resting surface; and an intermediate layer which includes odor-absorbent material. A method of eliminating pet odor comprises providing a resting surface for a pet; covering the resting surface with a disposable odor-absorbent cover; and fixing the disposable cover to the resting surface with the attachment member.

### FIELD OF INVENTION

The present invention relates to pet beds and, more particularly, to covers for enhancing the use of pet beds.

### BACKGROUND OF THE INVENTION

Typical pet beds utilize cushions, pillows or at least some type of fabric to increase comfort and attract the pet to lie on the pet bed. While such bedding materials generally work well for their intended purpose, as a result of normal use by a pet they frequently become so malodorous that they are disposed of. Cleaning of such bedding materials is typically difficult to perform given the bedding materials′ structure. Furthermore, pet owners often do not want to come in close contact with the malodorous bedding materials as would be required during cleaning.

In addition, some pets, specifically very young or aged pets, may experience incontinence which can quickly result in bedding which must be discarded.

Furthermore, beds for pets which experience severe shedding can become covered in fur and require frequent cleaning.

Therefore, there is a continuing significant need for improvements in the field of pet beds. More particularly, there is a need for facilitation of providing a clean bed without noxious odors.

Furthermore, there is a need for a device which reduces upkeep of pet beds.

In addition, there is a need for a pet bed device which absorbs liquids to facilitate absorption of odors and to prevent spilling onto other nearby surfaces.

There is also a need for such a device which can be quickly and securely fitted to existing pet beds.

Such a device would be an important improvement in the field of pet beds.

### OBJECTS OF THE INVENTION

It is an object of the invention to provide a pet bed cover which overcomes the noted problems in the prior art.

Another object of the invention is to provide a pet bed cover which facilitates elimination of pet odors.

Another object of the invention is to provide a pet bed cover which includes a attachment element for securing the cover to a pet bed quickly and easily.

Another object of the invention is to provide a pet bed cover which includes an outer layer having a weave-like structure to facilitate odor absorption.

Another object of the invention is to provide a pet bed cover which can be fitted about pet beds of various shapes and sizes.

Another object of the invention is to provide a pet bed cover which provides aesthetic appeal.

Still another object of the invention is to provide a pet bed cover which provides for reuse with different odor-absorption materials.

Yet another object of the invention is to provides a pet bed cover which is disposable.

These and other objects of the invention will be apparent from the following descriptions and from the drawings.

### BRIEF SUMMARY OF THE INVENTION

In accordance with the present invention, a pet bed cover is provided for protecting a pet bed against odors and/or liquids. The pet bed cover of this invention overcomes certain problems and shortcomings of the prior art, including those noted above, and provides a unique structure satisfying a number of specific needs.

In certain embodiments, the disposable cover for a pet bed comprises an outer layer having a perimeter; an elastic member located about the perimeter for fixing the cover with respect to the pet bed; and an inner layer for contact with the pet bed. The cover may further comprise an intermediate layer including odor-absorbent material. Such odor-absorbent material may be baking soda, a charcoal material, fragrant wood chips, or other similar materials. The intermediate layer may further comprise a deodorant such as fragrant wood chips, vanilla, soaps, or the like.

In certain embodiments, the outer layer is formed by a weave-like material facilitating absorption of odors by the odor-absorbent material. In such embodiments, odors easily come into contact with the odor-absorbent material and are dissipated.

In certain embodiments, the intermediate layer includes liquid-absorbent material. In combination with the weave-like outer layer, the liquid-absorbent material may reduce clean up of “accidents” by pets as well as the reduction of drool on the outer layer. In certain embodiments, the outer layer is formed by paper material. Such material may be similar to that used in disposable diapers.

The disposable cover may include an opening between the outer and inner layers such that the intermediate layer be removable. In such embodiments, the intermediate layer may be discarded without disposing of the inner and outer layers of the cover. Such layers may be washed and used with a new intermediate layer.

In certain embodiments, the disposable cover may include a draw string located about the perimeter for fixing the cover to the pet bed. Such embodiments may or may not include the elastic member which serves the same purpose.

The invention also includes a method of eliminating pet odor. In certain embodiments, such method comprises providing a resting surface for a pet (whether a pet bed or a couch, chair, pillow or other resting device usually used by people); covering the resting surface with a disposable cover, the cover having an outer layer having a perimeter, an attachment member located about the perimeter, an inner layer for contact with the resting surface, and an intermediate layer located between the outer and inner layers, the intermediate layer including odor-absorbent material; and fixing the disposable cover to the resting surface with the attachment member.

In such a method, the attachment member may be an elastic member and the disposable cover may be fixed to the pet bed by positioning a portion of the resting surface between the elastic member and a central portion of the disposable cover.

Alternatively, the method's attachment member may be a drawstring and the disposable cover may be fixed to the resting surface by positioning a portion of the resting surface between the draw string and a central portion of the disposable cover and tightening the draw string. In some embodiments, the attachment member may include both an elastic member and a draw string.

The method's odor-absorbent material may be baking soda, a charcoal material, fragrant wood chips, or of similar material. The intermediate layer may further comprise a deodorant such as fragrant wood chips, vanilla, soaps, or the like.

In certain embodiments of the method, the outer layer is formed by a weave-like material facilitating absorption of odors by the odor-absorbent material. In such embodiments, odors easily come into contact with the odor-absorbent material and are dissipated.

In certain embodiments of the method, the intermediate layer includes liquid-absorbent material. In combination with the weave-like outer layer, the liquid-absorbent material may reduce clean up of “accidents” by pets as well as the reduction of drool on the outer layer. In certain embodiments, the outer layer is formed by paper material. Such material may be similar to that used in disposable diapers.

The method's disposable cover may include an opening between the outer and inner layers such that the intermediate layer be removable. In such embodiments, the intermediate layer may be discarded without disposing of the inner and outer layers of the cover. Such layers may be washed and used with a new intermediate layer.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment. In the drawings:

FIG. 1 is a perspective view of an embodiment of a pet bed.

FIG. 2 is a perspective view of an embodiment of a pet bed cover covering the pet bed of FIG. 1 in accordance with the invention.

FIG. 3 is a cross sectional view of the pet bed cover and pet bed of FIG. 2 in accordance with the invention.

FIG. 4 is an overhead view of an embodiment of the pet bed cover fixed to a pet bed in accordance with the invention.

FIG. 5 is a perspective view of an embodiment of a pet bed cover having a removable intermediate layer in accordance with the invention.

FIG. 6 is a perspective view of an alternate embodiment of a pet bed.

FIG. 7 is a perspective view of an embodiment of a pet bed cover covering the pet bed of FIG. 6 in accordance with the invention.

### DETAILED DESCRIPTION OF PREFERRED EMBODIMENTS

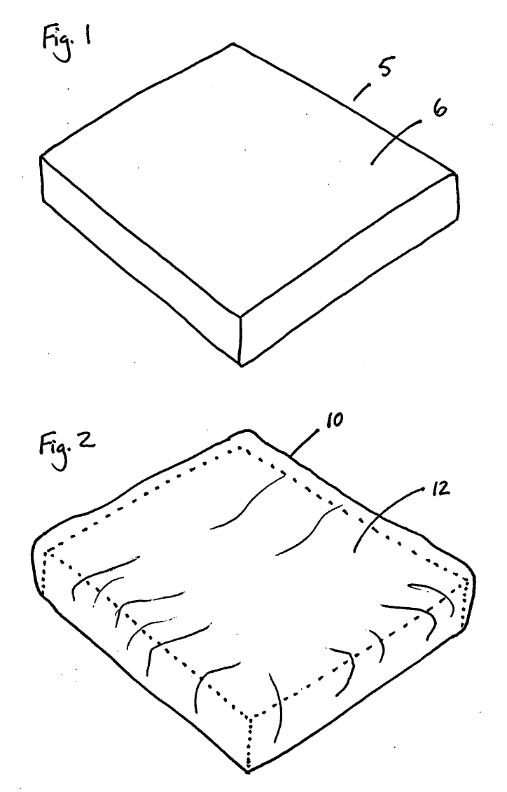

FIG. 1 depicts a standard rectangular pet bed 5 having a resting surface 6 on which a pet may lie. FIG. 2 shows such a pet bed 5 (in dotted lines) covered by an embodiment of the pet bed cover 10 of the invention. The exterior of the pet bed cover 10 is formed by outer layer 12.

FIG. 3 is a cross sectional view of the pet bed cover 10 and pet bed 5 seen in FIG. 2. Pet bed cover comprises outer layer 12, inner layer 18, and intermediate layer 20. Intermediate layer 20 is shown as extending only between the edges of pet bed 5; however, intermediate layer 20 may be coextensive with outer and inner layers 12, 18, extending between perimeters 14 of pet bed cover 10.

On the right side of FIG. 3, an elastic member 16 is shown near the perimeter 14 of pet bed cover 10. On the left side of FIG. 3, a draw sting 32 is shown near the perimeter of pet bed cover 10. Elastic member 16 and/or draw string 32 may be used to secure pet bed cover 10 to pet bed 5 so that pet bed 5 is not exposed. When pet bed 5 and pet bed cover 10 are secured together, a portion 7 of pet bed 5 is positioned between elastic member 16 and/or draw string 32 and a central portion 8 of pet bed cover 10.

If pet bed 5 and pet bed cover 10 are secured together only by elastic member 16, a pet owner may remove pet bed cover 10 from pet bed 5 simply by pulling perimeter 14 to allow portion 7 of pet bed 5 to pass out of cavity 36 formed by perimeter 14. If pet bed 5 and pet bed cover 10 are secured together by draw string 32, a pet owner may removed pet bed cover by unfastening draw sting 32 and expanding perimeter 14 to allow portion 7 of pet bed 5 to pass out of cavity 36 formed by perimeter 14.

Pet bed cover 10 may include cushioning or other pillow-like material to increase comfort to a pet. Such cushioning may be included in outer layer 12, inner layer 18, and/or intermediate layer 20. Alternatively, especially in cases of use of a pet bed cover 10 with a sufficiently cushioned pet bed 5, pet bed cover 10 may not include any further cushioning beyond the inherent cushioning properties of the outer layer 12, inner layer 18, and intermediate layer 20.

Intermediate layer 20 may include an odor-absorbent material to absorb pet odors. Such material may be baking soda, charcoal-type material, fragrant wood chips, or the like. Intermediate layer 20 may also include a deodorant such as fragrant wood chips, vanilla, soaps, or the like. Intermediate layer 20 may further include cushioning. In certain cases, a single material may serve as a odor-absorbent material, a deodorant, and cushioning.

Outer layer 12 may be comprising of fabric or of paper-type material which allows odors to penetrate to intermediate layer 20. Preferably, outer layer 12 wicks moisture away from the surface of pet bed cover 10 into intermediate layer 20.

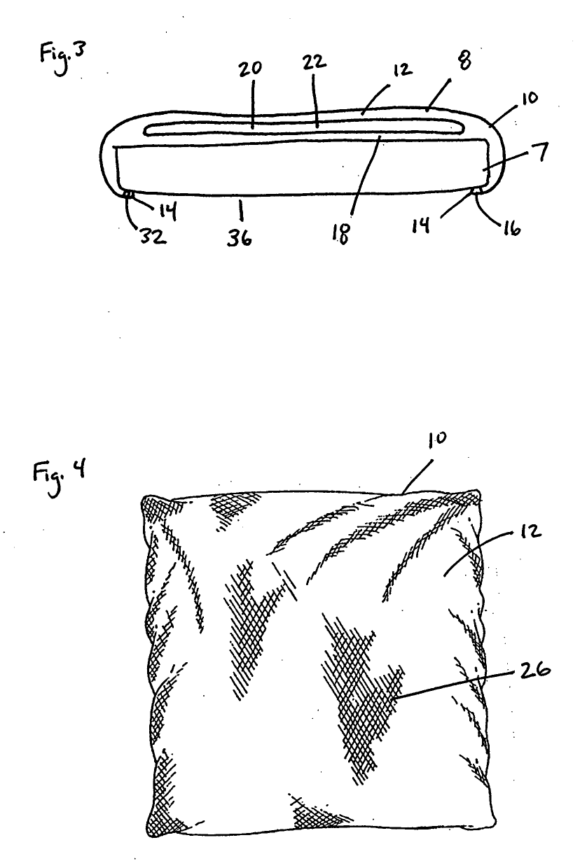

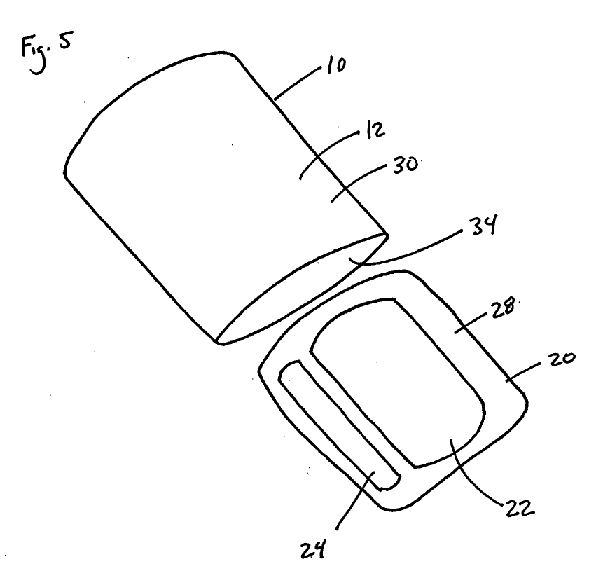

FIG. 4 depicts an overhead view of a pet bed cover 10 having an outer layer 12 which is made from weave-like material 26. As is easily understood, such weave-like material 26 facilitates odor absorption by the intermediate layer 20 located beneath the surface.

FIG. 5 shows an embodiment of pet bed cover 10 in which intermediate layer 20 may be inserted and removed from outer layer 12 and inner layer 18 through opening 34. Such removal allows for disposal of an intermediate layer 20 without requiring disposal of the rest of the pet bed cover 10. Intermediate layer 20 is shown having an odor-absorbent material 22, a deodorant 24, and a liquid absorbent material 28. In certain embodiments, a single material may serve as two or three of the odor-absorbent material 22, deodorant 24, and liquid absorbent material 28. After intermediate layer 20 is place inside pet bed cover 10, it may be secured there by closing opening 34 with a zipper, buttons, hook and loop style fasteners, or another known fastening system.

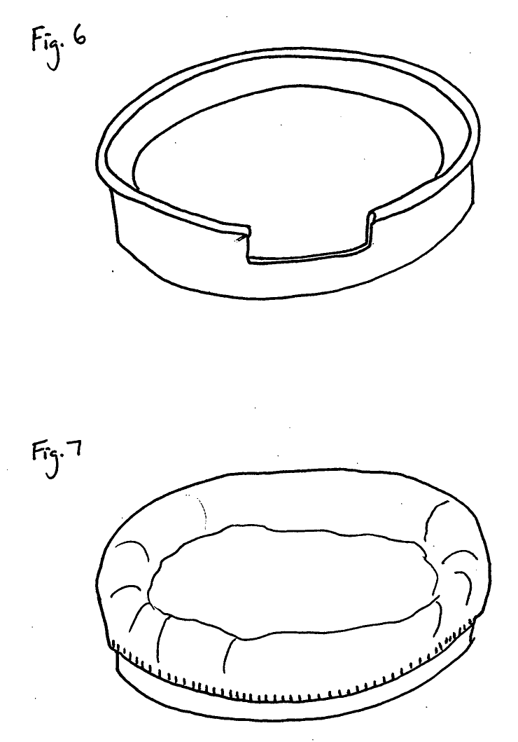

FIG. 6 shows an alternate style of pet bed 5. FIG. 7 shows a pet bed cover 10 in use with such alternate style. As is understood, pet bed cover 10 may be designed for and fitted to any style of pet bed 5 to provide for odor absorption, liquid absorption, deodorizing, and/or improving the aesthetic appeal of the pet bed. Pet bed cover 10 may be provided in a variety of colors, fabrics, and styles as is appropriate for the location of its use.

While the invention has been described with respect to specific embodiments by way of illustration, many modifications and changes will occur to those skilled in the art. It is, therefore, to be understood that the appended claims are intended to cover all such modifications and changes as fall within the true scope and spirit of the invention.

1. A disposable cover for a pet bed, the cover comprising:
an outer layer having a perimeter;
an elastic member located about the perimeter for fixing the cover with respect to the pet bed; and
an inner layer for contact with the pet bed.

2. The disposable cover of claim 1 further comprising an intermediate layer, the intermediate layer including odor-absorbent material

3. The disposable cover of claim 2 wherein the odor-absorbent material is baking soda.

4. The disposable cover of claim 2 wherein the intermediate layer further comprises a deodorant.

5. The disposable cover of claim 2 wherein the outer layer is formed by a weave-like material facilitating absorption of odors by the odor-absorbent material.

6. The disposable cover of claim 5 wherein the intermediate layer includes liquid-absorbent material.

7. The disposable cover of claim 2 wherein the outer layer is formed by paper.

8. The disposable cover of claim 1 further comprising a draw string located about the perimeter for fixing the cover to the pet bed.

9. The disposable cover of claim 2 further comprising an opening between the outer and inner layers such that the intermediate layer is removable.

10. A method of eliminating pet odor, the method comprising:
providing a resting surface for a pet;
covering the resting surface with a disposable cover, the cover having:
an outer layer having a perimeter;
an attachment member located about the perimeter;
an inner layer for contact with the resting surface; and
an intermediate layer located between the outer and inner layers, the intermediate layer including odor-absorbent material;
fixing the disposable cover to the resting surface with the attachment member.

11. The method of claim 10 wherein the attachment member is an elastic member and the disposable cover is fixed to the resting surface by positioning a portion of the resting surface between the elastic member and a central portion of the disposable cover.

12. The method of claim 10 wherein the attachment member is a drawstring and the disposable cover is fixed to the resting surface by positioning a portion of the resting surface between the draw string and a central portion of the disposable cover and tightening the draw string.

13. The method of claim 10 wherein the odor-absorbent material is baking soda.

14. The method of claim 10 wherein the intermediate layer further comprises a deodorant.

15. The method of claim 10 wherein the outer layer is formed by a weave-like material facilitating absorption of odors by the odor-absorbent material.

16. The method of claim 10 wherein the intermediate layer includes liquid-absorbent material.

17. The method of claim 10 wherein the outer layer is formed by paper.
